(19) United States
(12) Patent Application Publication
(10) Pub. No.: US 2007/0162780 A1
(43) Pub. Date: Jul. 12, 2007

(54) Method for controlling an operating frequency of a processor during playback of a recorded video

(76) Inventors: Yao-Yi Wang, Taipei (TW); Tung-Peng Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/328,184

(22) Filed: Jan. 10, 2006

(51) Int. Cl. G06F 1/04

(52) U.S. Cl. 713/600

(57) ABSTRACT

A method for controlling the operating frequency of a processor during video playback is disclosed. The method comprises extracting a pack of video data in which is embedded a plurality of data size information of a plurality of video data segments for playback. The plurality of data size information from the extracted pack of video data is read to determine the plurality of video data segment bitrates. The plurality of video segment bit rate is calculated from the plurality of data size information of the plurality of video data segments. The operating frequency of the processor is set according to the video data segment bitrate of each video data segment of the plurality of video data segments while playing the video data segment. As a result, the optimum processor operating frequency is utilized in order to provide the best quality of video playback while reducing the power consumption to a minimum.

### BACKGROUND OF THE INVENTION

1. Field of the Invention

The present invention relates to a method for adjusting an operating frequency of a processor during video playback. More specifically, the present invention discloses a method for dynamically adjusting an operating frequency of a processor during playback of a digitally recorded encoded video according to the bit rate of the recorded video to be decoded.

2. Description of the Prior Art

Traditionally, while playing a recorded video, a computer processor operates continuously at its maximum operating frequency. This consumes the maximum amount of power and correspondingly generates the maximum amount of heat. As processor operating frequencies increase, this becomes unnecessary, and a method was developed whereby the amount of video data to be decoded was estimated, the processor operating frequency was reduced, or “throttled”, to a lower frequency, and the video was decoded and played. This was a useful approach for constant bit rate (CBR) encoding, where the amount of video data per frame is approximately the same for every frame and thus for every sequence of frames or group of pictures (GOP).

However, video data is not uniformly complex. Some segments are highly variable and thus require more data to present a clear image, for example action sequences on a detailed background. Other segments are largely static and require very little data to create a clear image, such as titles and credits on a uniform neutral background. As a result, variable bit rate (VBR) encoding is used to encode the video, using more data per frame for complex highly variable sequences of frames, and less data per frame for relatively simple static sequences of frames.

Operating a processor at a fixed operating frequency on such VBR data leads to defects in playback, because although too much processing is available during low complexity video, wasting resources and power, too little is available during high complexity video and thus they cannot be decoded in a timely manner, causing pauses and/or jerky playback.

Although the video data can be buffered to a limited extent, the amount of data is enormous and would require considerable resources, driving up expense and power consumption. Also, the initial video data is often a title sequence or other low complexity data, which can result in an insufficient processor operating frequency setting.

In addition, the higher operating frequency needed to ensure adequate processing for decoding throughout the video playback consumes power and generates heat.

Therefore, to save power and reduce heat generation, as well as for other reasons, there is a need for improvement in processor operating frequency control during playback of a recorded video.

### SUMMARY OF THE INVENTION

To achieve these and other advantages and in order to overcome the disadvantages of the conventional method in accordance with the purpose of the invention as embodied and broadly described herein, the present invention provides a method to control an operating frequency of a processor during playback of a recorded video in order to optimize the quality of the video while eliminating excessive processing power consumption.

An objective of the method of the invention is to improve the performance of a computing system. The method comprises providing adequate processing ability to decode and display video in a consistent manner. The method further comprises providing an efficient method for estimating processing requirements and adjusting an operating frequency of a processor according to the estimated processing requirements.

Another objective of the method of the invention is to save power and reduce heat generation. This is especially important in portable computing systems for prolonging battery life.

To achieve these and other objectives, the present invention provides a method for dynamically adjusting the operating frequency of a processor during video playback according to a lookup table of bit rates calculated from the video data.

The method comprises extracting a pack of video data in which is embedded a plurality of data size information of a plurality of video data segments. The plurality of data size information from the extracted pack of video data is read to determine the plurality of video data segment bit rate. The average video data segment bit rate from the plurality of video data segment bit rate is then calculated. Finally, the operating frequency of the processor is set according to the average video data segment bit rate. As a result, the optimum processor operating frequency is utilized in order to provide the best quality of video playback while reducing the power consumption to a minimum.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIGS. 1a and 1b are diagrams illustrating the structure of a VOBU;

FIG. 2 is a diagram illustrating a linear correspondence between video data bit rate and processor operating frequency;

FIG. 3 is a flowchart illustrating a method of adjusting the operating frequency of a processor during video playback according to an embodiment of the present invention;

FIG. 4a is a flowchart illustrating a more detailed method of adjusting the operating frequency of a processor during video playback according to an embodiment of the present invention;

FIG. 4b is a flowchart illustrating a method of determining the plurality of video data segment bit rate according to an embodiment of the present invention; and

FIG. 4c is a flowchart illustrating a method of setting the operating frequency of a processor according to an embodiment of the present invention.

### DESCRIPTION OF THE PREFERRED EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. Acronyms and other descriptive terminology may be used merely for convenience and clarity and are not intended to limit the scope of the invention.

While the present invention is described in the context of DVD playback, it should be understood that the invention also can be employed in the playback of other disc formats, such as VCD, HD-DVD, Blu-Ray™, FVD, DVD+VR, DVD−VR, mini-DVD, and so forth.

In accordance with the DVD standard, the structure of a video object set (VOBS) is part of the logical data structure of a DVD video disc which is described in precise detail in the DVD Standard. A video object set (VOBS) comprises a number of video objects (VOBU). Each video object comprises an MPEG program stream, which is composed of a group of elementary streams. The program stream contains five packetized elementary streams: video, audio, sub-picture, presentation control information (PCI), and data search information (DSI). DSI is the navigation data utilized for searching and executing the seamless playback of a VOBU. The data search information comprises five segments: DSI information, playback information, angle information, VOBU search information (VOBU_SRI), and synchronous information. The PCI is the navigation data to control the presentation of a VOBU. The PCI comprises four pieces of information: PCI general information, angle information, highlight information, and recording information. The contents of the DSI and PCI are renewed for each VOBU.

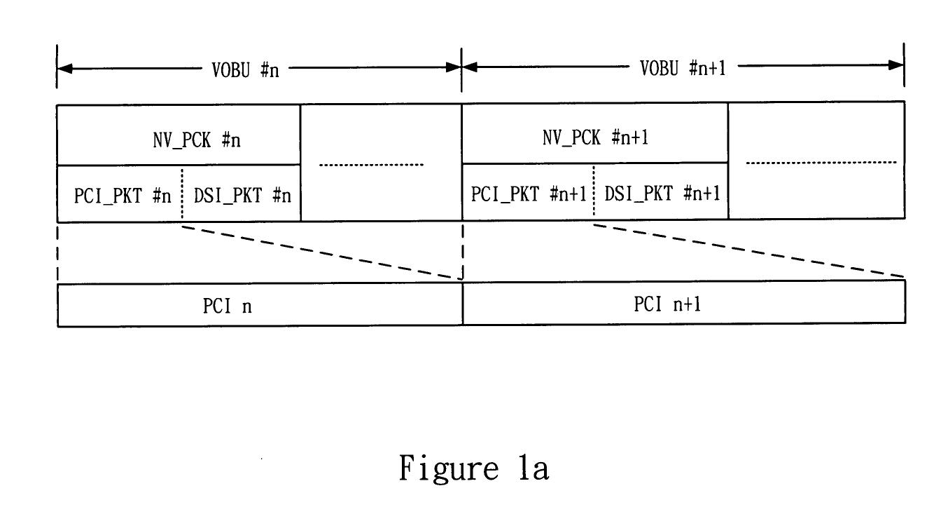

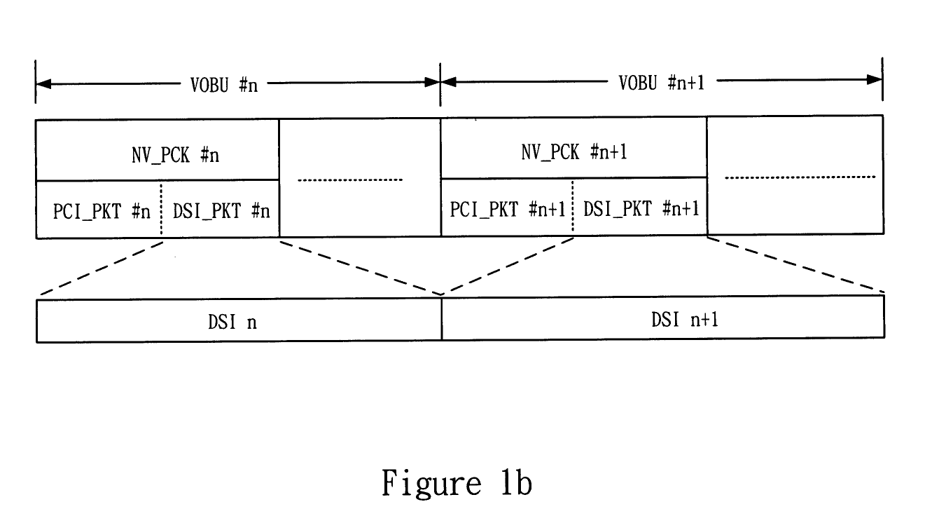

Refer to FIGS. 1a and 1b, which are diagrams illustrating the structure of a VOBU. Each VOBU comprises a navigation pack (NV_PCK), which is composed of navigation parameters, followed by the data of one or more Groups of Pictures (GOP), which is composed of a plurality of sequential frames. Each NV_PCK comprises presentation control information (PCI) in a PCI packet (PCI_PKT) and data search information (DSI) in a DSI packet (DSI_PKT).

The navigation parameters support navigation through images in an MPEG compatible group of pictures (GOP) or within a DVD video object unit (VOBU). Specifically, navigation parameters may include, for example, parameters identifying individual GOPs, or the number of GOPs in a video object unit (VOBU), or image data location information. Furthermore, the location information may include data identifying the size of image representative data, or data identifying MPEG reference frames in a VOBU or GOP, or data identifying image representative data start or end addresses, and so on. The location information may be given in the form of sector location, either absolute (from the beginning of the media) or relative (from the current sector) offset; in this case, the data size is calculated by determining the number of sectors and multiplying this number by the sector size (2048 bytes for the DVD standard; since there are 8 bits per byte, there are thus 16384 bits per sector).

The navigation pack is placed at the head of each VOBU. In this navigation pack, playback information for the VOBU and management information relating to the search data is recorded. As defined by the DVD video specifications, the VOBU has a video playback time of 0.4 sec-1 sec. Therefore, a navigation pack of recorded video data is read to acquire the information about the size of the image representative data. Next, the plurality of sizes of the image representative data are read, and then the durations of the plurality of video data segments are derived from the number of VOBUs to be played back for each video data segment multiplied by the video playback time of the VOBU.

The bit rates of the plurality of video data segments can be calculated by formula (1) as follows:
Bit rate=size of image representative data/duration (1)

Next, an overall average bit rate of the video data segments can be calculated from the plurality of bit rates of the plurality of video data segments to determine the required operating frequency of the processor. Then, the operating frequency of the processor can be set according to the average bit rate of the video data segments.

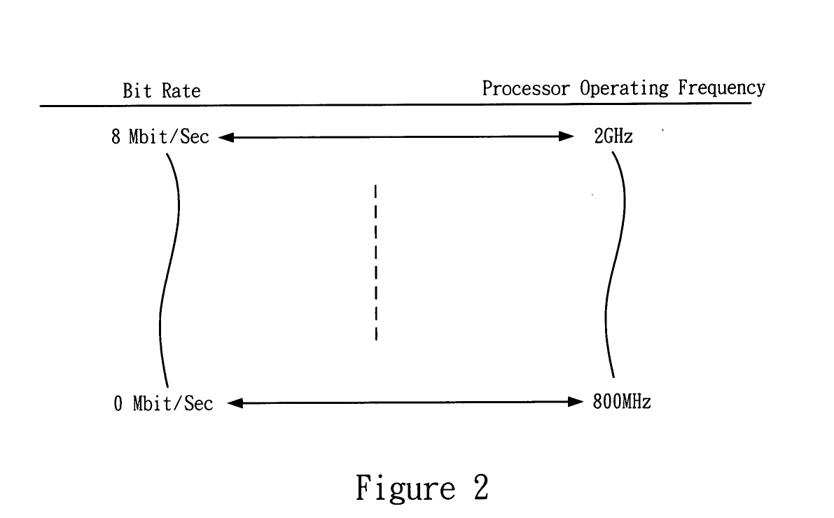

For example, but not limited to, a diagram illustrating a linear correspondence between video data bit rate and processor operating frequency is shown in FIG. 2. A lookup table of required processor operating frequency values can be determined in advance and provided with the method, according to the particular video encoding scheme being used and the known characteristics of processors. In addition, a default value of processor operating frequency can optionally be provided, so that the processor operating frequency can be set to a default state when the method is finished. Typically, this default would be the maximum processor operating frequency.

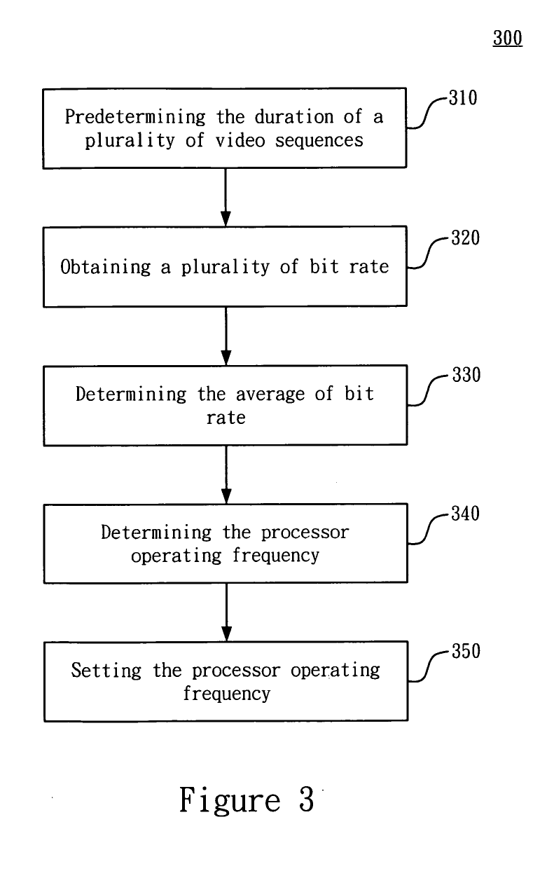

Refer to FIG. 3, which is a flowchart illustrating a method of adjusting the operating frequency of a processor during video playback according to an embodiment of the present invention.

The method 300 basically comprises predetermining the durations of a plurality of video sequences in step 310. The plurality of bit rate is obtained in step 320 in order to determine the average bit rate in step 330. Finally, the operating frequency is determined in step 340 and the processor operating frequency is set in step 350.

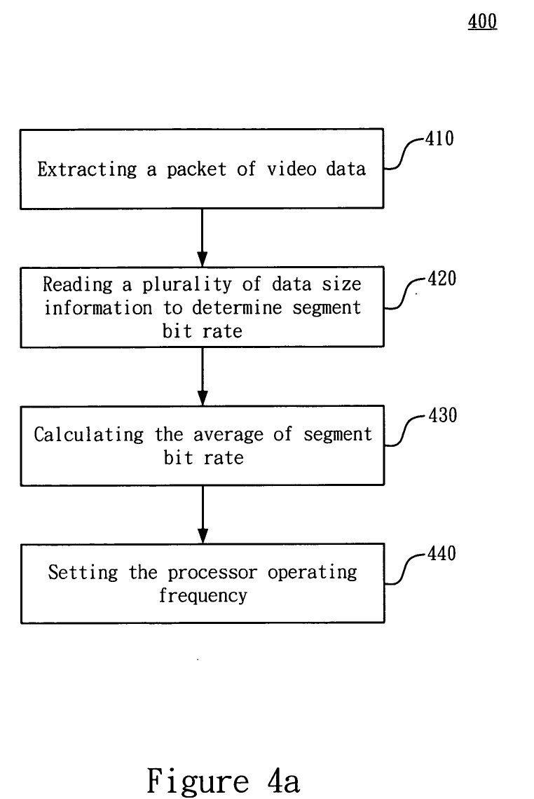

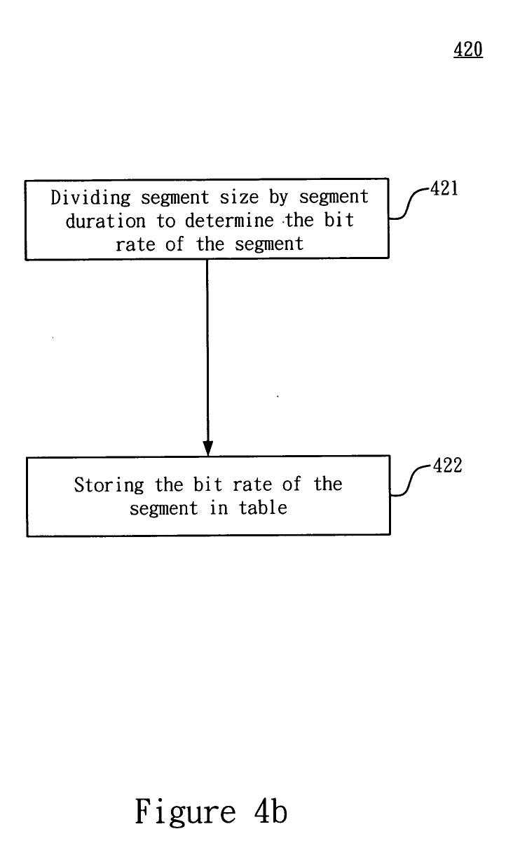

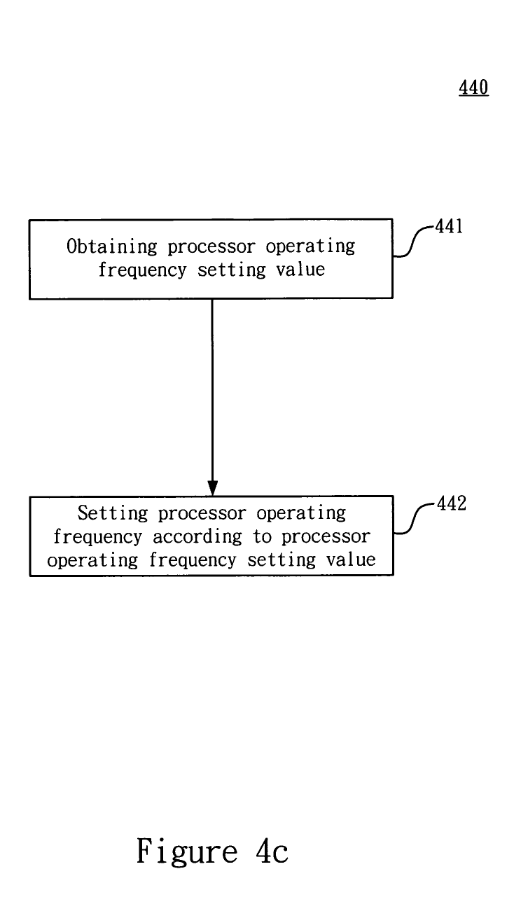

Refer to FIG. 4a, which is a flowchart illustrating a more detailed method of adjusting the operating frequency of a processor during video playback according to an embodiment of the present invention.

The method 400 comprises extracting a pack of video data in step 410. A plurality of data size information of a plurality of video data segments is embedded in the video data. In step 420 the plurality of data size information from the extracted pack of video data is read to determine the plurality of video data segment bit rate. In step 430 the average video data segment bit rate from the plurality of video data segment bit rate is calculated. The method 400 concludes in step 440 by setting the operating frequency of the processor according to the average video data segment bit rate.

Refer to FIG. 4b, which is a flowchart illustrating a method of determining the plurality of video data segment bit rate according to an embodiment of the present invention.

In determining the plurality of video data segment bit rate, the video data segment size of a video data segment is divided by the video data segment duration of the video data segment in order to determine a bit rate of the video data segment for each video data segment of the plurality of video data segments in step 421. In step 422 each bit rate of the video data segment is stored in a video data segment bit rate lookup table.

Refer to FIG. 4c, which is a flowchart illustrating a method of setting the operating frequency of a processor according to an embodiment of the present invention.

In step 441, a processor frequency setting value is obtained by referring to a lookup table of processor frequency setting values. In step 442, the operating frequency of the processor is set according to the processor frequency setting value.

The method of the present invention can be used in video playback for digital video playback from a wide variety of sources, including VCD, DVD, HD-DVD, Blu-Ray™, FVD, DVD+VR, DVD−VR, mini-DVD or other source of digitally encoded video data. It is suitable for MPEG2, MPEG4, WMV, RealVideo, QuickTime, and other digital video formats.

The method of the present invention can furthermore be used on central processing units (CPUs) and/or video card processors. Due to the low computational overhead, reduced power consumption and thus lower heat generation, it is well suited for devices such as laptops and portable DVD players.

In summary, the method for controlling the operating frequency of a processor during playback of a recorded video of the present invention comprises extracting a pack of video data in which is embedded a plurality of data size information of a plurality of video data segments for playback. Then the plurality of data size information from the extracted pack of video data is read to determine the plurality of video data segment bit rate. The plurality of video segment bit rate is calculated from the plurality of data size information of the plurality of video data segments. The bit rate is calculated by dividing the data size by the duration. Finally, the operating frequency of the processor is set according to the video data segment bit rate of each video data segment of the plurality of video data segments while playing the video data segment.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for controlling an operating frequency of a processor during playback of a recorded video, comprising:
extracting a pack of video data in which is embedded a plurality of data size information of a plurality of video data segments;
reading the plurality of video data size information from the extracted pack of video data to determine a plurality of video data segment bit rate;
calculating an average video data segment bit rate from the plurality of video data segment bit rate; and
setting the operating frequency of the processor according to the average video data segment bit rate.

2. The method of claim 1, where determining the plurality of video data segment bit rate comprises:
dividing the video data segment size of a video data segment by a video data segment duration of said video data segment to form a bit rate of said video data segment for each video data segment of the plurality of video data segments; and
storing each bit rate of said video data segment in a video data segment bit rate lookup table.

3. The method of claim 1, where setting the operating frequency of the processor comprises:
looking up a processor frequency setting value in a table of processor frequency setting values; and
setting the operating frequency of the processor according to the processor frequency setting value.

4. The method of claim 1, further comprising playing the plurality of video data segments.

5. The method of claim 4, further comprising setting the operating frequency of the processor to a default value after completing playing the plurality of video data segments.

6. The method of claim 1, where the video data is from a VCD disc, a DVD disc, a HD-DVD disc, a Blu-Ray disc, a FVD disc, DVD+VR disc, DVD−VR disc, or mini-DVD disc.

7. A method for controlling an operating frequency of a processor during playback of a recorded video, comprising:
determining a plurality of bit rate of a plurality of video data segments;
determining an average bit rate of the plurality of video data segments;
determining an optimal processor operating frequency; and
setting the processor operating frequency according to the optimal processor operating frequency.

8. The method of claim 7 further comprising determining a plurality of durations of a plurality of video data segments;

9. The method of claim 7, where determining the plurality of bit rate of the plurality of video segments comprises dividing video segment size by video segment duration.

10. The method of claim 7, where the optimal processor operating frequency is stored in a lookup table.

11. The method of claim 7, where setting the operating frequency of the processor comprises:
looking up a processor frequency setting value in a table of processor frequency setting values; and
setting the operating frequency of the processor according to the processor frequency setting value.

12. The method of claim 7, where the processor is a central processing unit.

13. The method of claim 7, where the processor is a video card graphical processor.

14. The method of claim 7, where the video data is from a VCD disc, a DVD disc, a HD-DVD disc, or a Blu-Ray disc.

15. A method for controlling an operating frequency of a processor during playback of a recorded video, comprising:
reading a plurality of video data size information from a pack of video data;
predetermine a video data segment duration;
calculating a video data segment bit rate from the video data segment size and the video data segment duration; and
setting the operating frequency of the processor according to the video data segment bit rate.

16. The method of claim 15, where calculating the video data segment bit rate comprises:
dividing the video data segment size of the video data segment by the video data segment duration of the video data segment to obtain the video data segment bit rate.

17. The method of claim 15, where setting the operating frequency of the processor comprises:
looking up a processor frequency setting value in a table of processor frequency setting values.

18. The method of claim 15, where setting the operating frequency of the processor further comprises:
setting the operating frequency of the processor according to the processor frequency setting value.

19. The method of claim 15, further comprises setting the operating frequency of the processor to a default value after completing playing the plurality of video data segments.

20. The method of claim 1, where the video data is from a VCD disc, a DVD disc, a HD-DVD disc, a Blu-Ray disc, a FVD disc, a DVD+VR disc, a DVD-VR disc, or a mini-DVD disc.
